(19) United States
(12) Patent Application Publication
(10) Pub. No.: US 2017/0282514 A1
(43) Pub. Date: Oct. 5, 2017

(54) EASY PEEL SEALANT FILM

(71) Applicant: HOSOKAWA YOKO CO., LTD., Tokyo (JP)

(72) Inventors: Tomohiro ASAKAWA, Tokyo (JP); Takuro MARUYAMA, Tokyo (JP); Yohei KAGEYAMA, Tokyo (JP)

(21) Appl. No.: 15/472,617

(22) Filed: Mar. 29, 2017

(30) Foreign Application Priority Data
Mar. 30, 2016 (JP) 2016-069220

(51) Int. Cl. B32B 27/32; B32B 27/08; B32B 37/12; B29C 47/00; B65D 43/02; B29C 55/12; B29C 71/04; B29C 65/48; B65D 33/16; B32B 7/12; B29C 55/00

(52) U.S. Cl. CPC B32B 27/32; B32B 7/12; B32B 27/08; B32B 37/12; B29C 47/0004; B29C 47/0021; B29C 47/0057; B29C 55/005; B29C 55/12; B29C 71/04; B29C 65/48; B65D 33/16; B65D 43/02; B32B 2323/046; B32B 2323/10; B32B 2439/46; B29K 2023/0633

(57) ABSTRACT

An easy peel sealant film includes at least a support layer and a peel layer. The support layer has a composition which contains 100 to 70 mass % of a linear low-density polyethylene, and 0 to 30 mass % of a propylene homopolymer. The peel layer has a composition which contains 40 to 60 mass % of a low-density polyethylene, 10 to 20 mass % of a high-density polyethylene, and 20 to 50 mass % of a propylene homopolymer. The propylene homopolymer in the support layer and the propylene homopolymer in the peel layer have a melt flow rate of 1 g/10 min to 9 g/10 min.

### CROSS-REFERENCE TO RELATED APPLICATION

This application claims priority from Japanese Patent Application No. 2016-069220 filed with the Japan Patent Office on Mar. 30, 2016, the entire content of which is hereby incorporated by reference.

### BACKGROUND

### 1. Technical Field

The present disclosure relates to an easy peel sealant film.

### 2. Related Art

Three-dimensional containers with flange portions, such as cups and trays manufactured by deep drawing and the like, are widely being used in the market as sealed containers. The sealed containers are sealed by affixing the flange portion and a planar lid member after contents are stored in the container.

The lid member of the sealed containers can be destroyed and opened by, e.g., penetrating and tearing away the lid member, thus allowing the contents to be extracted. However, such method tends to leave residual pieces on the container upper surface. In addition, because the method requires an opening tool, such as a cutter, the opening process is cumbersome. Accordingly, sealed containers in which an easy peel sealant film is used as the lid member are preferred and frequently used. The easy peel sealant film may be affixed by heating and pressing so as to seal the container. After the sealing, when the sealed container is to be opened, the lid member can be easily peeled off. In this way, from the flange portion, to which the lid member of the container is affixed, the lid member can be peeled off without using any tool, and the sealed container can be easily opened.

Many of the easy peel sealant films have a multilayer structure. In particular, in a delamination-type easy peel sealant film, a layer (peel layer) that adheres onto an adherend, such as a container, and an adjacent layer (support layer) are peeled from each other. After the peeling, a clear peel trace is formed by a peel layer of the delamination-type easy peel sealant film that remains on the adherend surface. The peel trace provides the proof that the adherend and the lid member have been reliably sealed. Accordingly, the delamination-type easy peel sealant film is frequently used as a lid member with which the seal can be easily confirmed.

However, when peeling the lid member from the adherend when opening, the lid member may fail to be smoothly peeled, and instead be peeled while being caught in a phenomenon called “knocking”. This is due to an uneven force required for peeling, resulting in intermittent changes in peel strength. When the phenomenon is present, smoothness is lost during the peeling, and a very rough sense of peeling is caused.

Further, the so-called fluffing or film residue may be caused. If fluffing is caused, stringing may be caused between the peel surfaces during peeling, resulting in napping observed on the peel surfaces after peeling. FIG. 3 illustrates a case of the adherend surface being the upper surface or a flange surface 5 of the cup container 4. In this case, if a film residue is produced, a peel layer 1 remains as a thin film in portions other than the adherend surface, and may even extend over the content storing portion of the cup container 4. Such fluffing and film residue both introduce a cause of defective appearance, which reduces the product's value.

According to JP-A-2007-326353, the thickness of a peel layer to be peeled which is included in a multilayer easy peel sealant film is set to 2 to 10 μm so as to prevent the fluffing and film residue when opening a package.

### SUMMARY

An easy peel sealant film according to the present embodiment includes at least a support layer and a peel layer. The support layer has a composition which contains 100 to 70 mass % of a linear low-density polyethylene, and 0 to 30 mass % of a propylene homopolymer. The peel layer has a composition which contains 40 to 60 mass % of a low-density polyethylene, 10 to 20 mass % of a high-density polyethylene, and 20 to 50 mass % of a propylene homopolymer. The propylene homopolymer in the support layer and the propylene homopolymer in the peel layer have a melt flow rate of 1 g/10 min to 9 g/10 min.

### BRIEF DESCRIPTION OF THE DRAWINGS

FIG. 1 is a cross sectional view of an easy peel sealant according to an embodiment of the present disclosure;

FIG. 2 is a cross sectional view illustrating the process of a lid member including an easy peel sealant film according to the embodiment of the present disclosure being peeled from a container; and

FIG. 3 is a partial cross sectional view illustrating a film residue which is produced after a lid member including a typical easy peel sealant film is peeled from a container.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

JP-A-2007-326353 teaches that a multilayer easy peel sealant film can be manufactured by an extrusion lamination process, a coextrusion blown film process, or a coextrusion T-die process. Generally, the coextrusion blown film process may be preferred as it helps to reduce cost. However, compared with the coextrusion T-die process or the extrusion lamination process which involve rapid cooling of molten resin in a short time using cooling rolls that go through cooling water, it is difficult to manufacture a thin film having a uniform thickness by the coextrusion blown film process, which does not use cooling rolls and is based on regular air-cooling. It has been difficult to stably manufacture a peel layer of 2 to 10 μm that is included in the easy peel sealant film according to JP-A-2007-326353 by the coextrusion blown film process.

An object of the present disclosure is to provide an easy peel sealant film with which, when used as a lid member sealant, knocking can be suppressed, which does not have the defective appearance due to fluffing or film residue and the like, and which can be manufactured by blown film formation.

The present disclosure will describe the following aspects.

[1] An easy peel sealant film includes at least a support layer and a peel layer. The support layer has a composition which contains 100 to 70 mass % of a linear low-density polyethylene, and 0 to 30 mass % of a propylene homopolymer. The peel layer has a composition which contains 40 to 60 mass % of a low-density polyethylene, 10 to 20 mass % of a high-density polyethylene, and 20 to 50 mass % of a propylene homopolymer. The propylene homopolymer in the support layer and the propylene homopolymer in the peel layer have a melt flow rate of 1 g/10 min to 9 g/10 min.

[2] A laminate includes: the easy peel sealant film according to [1]; and a base material.

[3] A container with a lid includes: a lid member including the laminate according to [2]; and a container.

[4] A packaging bag includes the laminate according to [2] in a bag shape with the peel layer disposed on an inner side.

[5] A method for manufacturing the easy peel sealant film of [1] includes forming a film using an blown film molding process.

According to the above aspects, there is provided an easy peel sealant film with which, when used as a lid member sealant, knocking can be suppressed, which does not have the defective appearance due to fluffing or film residue and the like, and which can be manufactured by blown film formation.

In the following, an embodiment of the present disclosure will be described in detail.

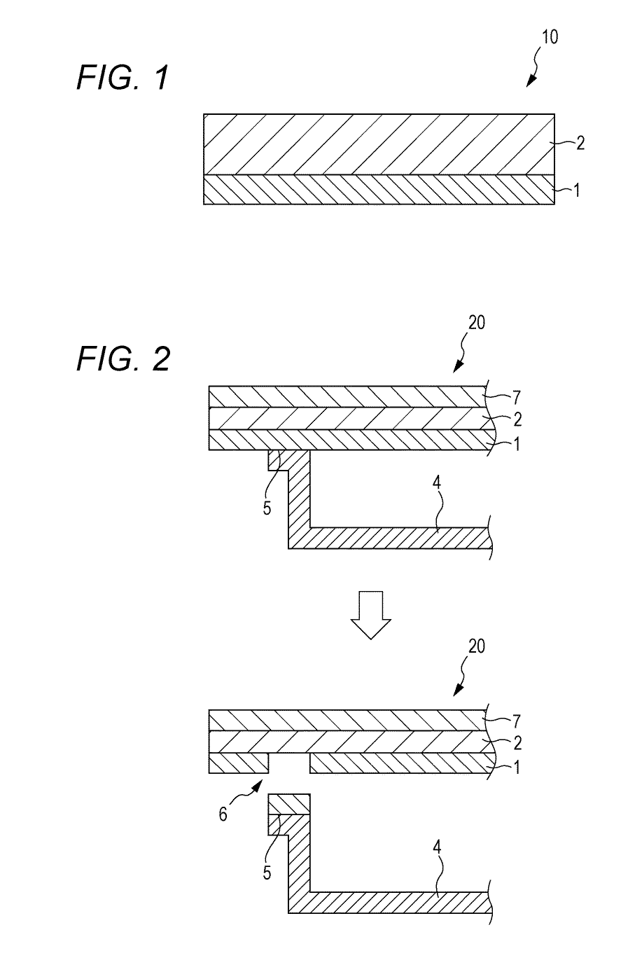

An easy peel sealant film according to the present disclosure includes at least a support layer and a peel layer. As illustrated in FIG. 1, the peel layer 1 constitutes one surface layer of an easy peel sealant film 10, and has a surface that contacts an adherend when the easy peel sealant film is affixed to the adherend. In the case where the easy peel sealant film is used for a container with a lid or bag, the peel layer 1 provides an inner layer having an inner surface that contacts the contents. The support layer 2 is a layer adjacent to the peel layer 1. After the easy peel sealant film of the present embodiment is affixed, the easy peel sealant film can be peeled. The easy peel sealant film is a delamination-type sealant film in which, when peeled, separation occurs between the peel layer 1 and the support layer 2.

With reference to FIG. 2, the delamination type of peel will be described. FIG. 2 is a cross sectional view illustrating the process in which a lid member (laminate) 20 including a laminate of the easy peel sealant film 10 of the present embodiment and a base material 7 is being peeled from a container 4. In the example of FIG. 2, at the start of peeling, the peel layer 1 of the easy peel sealant film 10 is ruptured, whereby a peel start portion 6 is formed. Then, the peeling initiated from the peel start portion 6 proceeds along the faces of the peel layer 1 and the support layer 2.

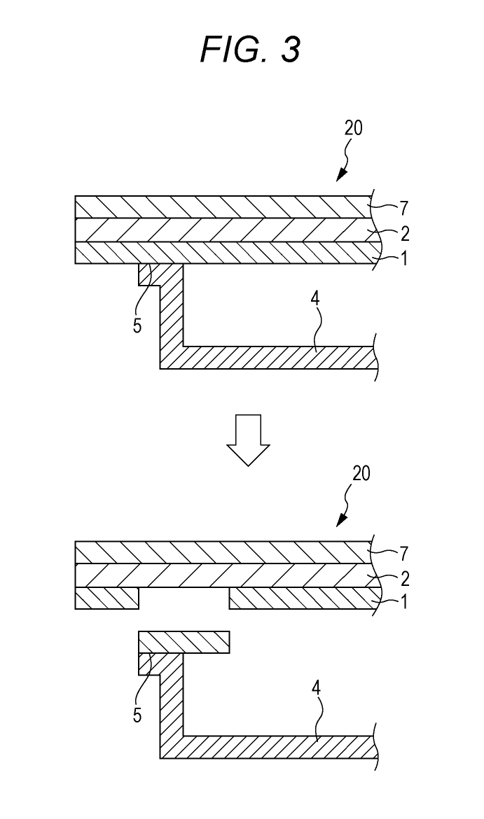

Accordingly, the lid member 20 is peeled from the container 4. Thereafter, when the peeling has proceeded by the same length as the width of the flange surface 5, the peel layer 1 ruptures again. This completes the peeling of the lid member 20 from the container 4. Consequently, a part of the peel layer 1 remains as a peel trace on the flange surface 5 of the container 4. In the examples of FIGS. 2 and 3, for ease of description, the lid member 20 and the container 4 are affixed to each other over the same width as the width of the flange surface 5. Usually, however, the lid member 20 and the container 4 are affixed to each other over a width narrower than the width of the flange surface 5.

### <Peel Layer>

In the easy peel sealant film according to the present embodiment, the peel layer is made of a composition which contains 40 to 60 mass % of a low-density polyethylene, 10 to 20 mass % of a high-density polyethylene, and 20 to 50 mass % of a propylene homopolymer.

### (Peel Layer: Low-Density Polyethylene)

The low-density polyethylene used in the present embodiment is a high pressure low density polyethylene.

The high pressure low density polyethylene is manufactured, using a radical initiator of oxygen in the air or peroxide as a catalyst, through bulk polymerization of ethylene under the condition of a pressure of 1000 to 4000 atmospheres and a temperature of 100° C. to 350° C. Generally, the high pressure low density polyethylene is known to have long-chain branches and a large number of branches among polyethylene-based resins.

The low-density polyethylene used in the present embodiment preferably has a density of 0.915 to 0.930 g/cm³, and a melt flow rate (hereafter “MFR”) of 0.5 to 2.0 g/10 min.

The values of densities in the present disclosure are measure by the density gradient tube method according to JIS K 7112, D-process. MFR values are measured according to JIS K 7210 at a load of 21.18 N. The measurement temperature of MFR of polyethylene-based resins of the low-density polyethylene, the high-density polyethylene, and a linear low-density polyethylene is 190° C. The measurement temperature of a polypropylene-based resin which will be described below is 230° C.

When the density of the low-density polyethylene is less than 0.915 g/cm³, the peel layer extends without being cleanly ruptured at the start of peeling. As a result, fluffing or film residue tends to be caused. When the MFR of the low-density polyethylene is outside the range of 0.5 g/10 min to 2.0 g/10 min, stable film formation by the blown film molding process tends to become difficult.

The content of the low-density polyethylene is preferably 40 to 60 mass % and more preferably 50 to 60 mass % relative to the total mass of the composition.

When the content of the low-density polyethylene is in the above numerical value ranges, peel strength can be adjusted to within a desired range. In addition, satisfactory appearance of the peel surface can be obtained.

### (Peel Layer: High-Density Polyethylene)

The high-density polyethylene used in the present embodiment has a density of 0.940 to 0.965 g/cm³, and a MFR of 15 to 20 g/10 min.

When the density of the high-density polyethylene is less than 0.940 g/cm³, the appearance of the peel portion may be degraded.

A high-density polyethylene that has a MFR of less than 15 g/10 min may induce fluffing or stringing at the time of peeling and may make the appearance of the peel portion worse, and is therefore not preferable. On the other hand, a high-density polyethylene that has a MFR in excess of 20 g/10 min may lead to a decrease in viscosity during film formation and may make film formation difficult, and is therefore not preferable.

The high-density polyethylene contained in the peel layer suppresses the fluffing or stringing which may be induced when the peel layer is separated at the time of peeling. That is, the high-density polyethylene is a component which provides the peel layer with the property for causing the rupture thereof to proceed in a brittle rather than ductile manner.

High-density polyethylenes manufactured by various manufacturing processes, such as a bulk process, a solution process, a slurry process, and a gaseous phase process, are available in the market. Any of the high-density polyethylenes may be preferably used in the easy peel sealant film according to the present disclosure.

In the present embodiment, a high-density polyethylene manufactured using any catalyst or by any method may be used. A specific example of the catalyst that may be preferably used is a high-density polyethylene manufactured using a Ziegler-Natta catalyst, a single-site catalyst or the like.

Generally, the polyethylene obtained with the use of a single-site catalyst has a narrower molecular weight distribution than the polyethylene manufactured using a Ziegler-Natta catalyst. The high-density polyethylene according to the present embodiment is also a kind of polyethylene. The high-density polyethylene, which is manufactured and obtained with the use of a single-site catalyst, having such narrow molecular weight distribution helps to decrease variations in peel strength, and may be more preferably used.

The content of the high-density polyethylene is 10 to 20 mass % relative to the total mass of the composition.

When the content of the high-density polyethylene is not less than the lower limit value, satisfactory appearance of the peel surface can be obtained.

When the content of the high-density polyethylene is not more than the upper limit value, it becomes possible to lower rigidity and suppress knocking at the time of peeling.

### (Peel Layer: Propylene Homopolymer)

Polypropylene-based resins, which are polymers of propylene monomer, are generally classified by their composition into homopolypropylene that is a homopolymer of propylene, and a random polypropylene or block polypropylene that is a copolymer of propylene and ethylene or other olefins.

The propylene homopolymer used in the peel layer included in the easy peel sealant film of the present embodiment is a polypropylene-based resin corresponding to the aforementioned homopolypropylene. If a propylene copolymer of a random polypropylene and a block polypropylene is used, the affinity with the polyethylene component contained in the peel layer will be increased. This will lead to much fluffing on the peel surface that appears as if ripped off, resulting in a defective appearance. Accordingly, the propylene copolymer is not preferable.

The MFR of the propylene homopolymer used in the present embodiment is 1.0 g/10 min to 9.0 g/10 min and preferably 1.0 to 7.0 g/10 min. A MFR of less than 1 g/10 min may lead to a decrease in peel strength and is therefore not preferable. A MFR in excess of 9 g/10 min may cause significant stringing and lead to poor appearance, and is therefore not preferable. Generally, the density of the propylene homopolymer is 0.880 g/cm³ to 0.920 g/cm³.

The easy peel sealant film of the present embodiment is a delamination-type sealant film. That is, when the film is peeled, the peeling proceeds between a peel layer and a support layer thereof. Generally, in order for the easy peel sealant film to be the delamination-type sealant film including the peel layer and the support layer, the peel strength between the peel layer and the support layer is required to be lower than the peel strength between the peel layer and the adherend. The influence on the relation of such peel strength by the propylene homopolymer will be described below.

The propylene homopolymer contained in the peel layer of the easy peel sealant film of the present embodiment functions as an adhesion increasing component for the interface between the peel layer and the adherend when the adherend is polypropylene. Accordingly, the propylene homopolymer is effective in causing reliable delamination. In addition, the propylene homopolymer contained in the peel layer serves as an adhesion inhibiting component for the interface between the peel layer and the adherend when the adherend is polyethylene. Accordingly, when the content of the propylene homopolymer in the peel layer is excessive, the peel strength between the peel layer and the adherend becomes lower than the peel strength between the peel layer and the support layer. As a result, the peel pattern may change from the delamination to the interfacial peeling between the contact surfaces of the peel layer and the adherend.

The content of the propylene homopolymer is 20 to 50 mass % and preferably 30 to 40 mass % relative to the total mass of the composition.

When the content of the propylene homopolymer is not less than the lower limit value, the peel strength can be reduced in applications where the adherend is polyethylene. Accordingly, the sealant film has the easy peel property.

When the content of the propylene homopolymer is not more than the upper limit value, the peel strength can be reduced in applications where the adherend is polypropylene. Accordingly, the sealant film has the easy peel property.

In the composition, there may be compounded, as needed, polyolefin-based resins such as polybutene and an ultraviolet absorbing agent, a lubricant, an anti-blocking agent, a coloring agent, or other additives that may be used in synthetic resin films, to the extent that the object of the present embodiment would not be compromised.

### <Support Layer>

The support layer included in the easy peel sealant film of the present embodiment is a layer which is adjacent to the peel layer and which is delaminated from the peel layer when the easy peel sealant film is peeled. In this case, the peel layer remains in the state of being adhered to the adherend. Accordingly, the sealant film serves as a delamination-type sealant film

The support layer has a composition containing 100 to 70 mass % of a linear low-density polyethylene, and 0 to 30 mass % of a propylene homopolymer.

### (Support Layer: Linear Low-Density Polyethylene)

The linear low-density polyethylene preferably has a density of 0.915 g/cm³ to 0.930 g/cm³, and a MFR of 0.5 to 2.5 g/10 min.

If the density of the linear low-density polyethylene is less than 0.915 g/cm³, defective peel appearance tends to be caused by fluffing.

If the density exceeds 0.930 g/cm³, the rigidity of the easy peel sealant film will be increased. Accordingly, knocking tends to be caused at the time of peeling. The support layer, from the viewpoint of a thickness ratio, corresponds to a main layer of the easy peel sealant film of the present embodiment. If the MFR exceeds 2.5 g/10 min, stable film formation by the blown film process becomes difficult.

The linear low-density polyethylene is a kind of polyethylene also referred to as a straight-chain low-density polyethylene. The linear low-density polyethylene is a copolymer of ethylene and an α-olefin, such as 1-butene, 1-hexene, 1-octene, and 4-methyl-1-pentene. The linear low-density polyethylene, from the viewpoint of film formation stability, is preferably a linear low-density polyethylene polymerized using a metallocene catalyst or a single-site catalyst.

The content of the linear low-density polyethylene is preferably 100 to 70 mass % and more preferably 80 to 70 mass % relative to the total mass of the composition.

When the content of the linear low-density polyethylene is in the numerical value ranges, the peel strength can be adjusted to within a desired range. In addition, satisfactory appearance of the peel surface can be obtained.

### (Support Layer: Propylene Homopolymer)

The propylene homopolymer used in the support layer included in the easy peel sealant film of the present embodiment is the same propylene homopolymer as used in the above-described peel layer. Use of the same propylene homopolymer in the peel layer and the support layer helps to suppress a decrease in peel strength, and is therefore preferable.

When a propylene homopolymer is compounded in the support layer, the adhesive strength at the interface between the support layer and the peel layer is increased. Accordingly, the peel strength of the easy peel sealant film can be increased without causing either fluffing or the development of a film residue. If the propylene homopolymer compounded in the support layer exceeds 30 mass %, the peel strength is increased. This may lead to a difficulty in opening, depending on the size of the peel interface or the consumer. Accordingly, excessive propylene homopolymer is not preferable.

Also, use of polymers other than a propylene homopolymer, such as a block copolymer or a random copolymer, may invite a defective appearance and is therefore not preferable.

The content of the propylene homopolymer is 30 mass % or less, preferably 30 to 10 mass %, and more preferably 30 to 20 mass % relative to the total mass of the composition. When the content of the propylene homopolymer is in the numerical value ranges, the peel strength can be adjusted to within a desired range. In addition, satisfactory appearance of the peel surface can be obtained.

In the composition, there may be compounded, as needed, polyolefin-based resins such as polybutene and an antioxidant, an ultraviolet absorbing agent, a lubricant, an anti-blocking agent, a coloring agent, or other additives that may be used in synthetic resin films, to the extent that the object of the present embodiment would not be compromised.

The total thickness of the easy peel sealant film of the present embodiment is not particularly limited. The thickness may be about 15 μm to 100 μm, preferably 20 μm to 50 μm, and even more preferably 30 μm to 40 μm. Under 15 μm, stable film formation by the coextrusion blown film process may become difficult. In the case where the easy peel sealant film is used for a lid member having a small weight load, or a packaging bag for storing lightweight contents, a total thickness in excess of 50 μm may lead to a cause for unwanted cost increase.

The total thickness may be measured by a method using a contact-type mechanical thickness gauge, or a thickness gauge utilizing the attenuation ratio of ultrasonic waves or radiation. By observing a film cross section with an optical microscope, the thickness of the peel layer and the thickness of the support layer can also be measured in addition to the total thickness.

In the easy peel sealant film of the present embodiment, the thickness of the peel layer may be preferably 10 to 20% of the total thickness.

When the thickness of the peel layer is not less than the lower limit value, the peel layer having a more uniform thickness can be obtained by coextrusion blown film formation.

When the thickness of the peel layer is not more than the upper limit value, the required strength for rupturing the peel layer at the time of peeling, i.e., the peel start resistance, is decreased. This makes it possible to perform peeling with a smaller force.

As a result, the scattering of the contents at the time of peeling following the rupture can be more effectively suppressed.

For example, the thickness of the peel layer is preferably 4 μm to 10 μm.

The thickness of the support layer included in the easy peel sealant film of the present embodiment is preferably 80 to 90% of the total thickness.

For example, the thickness of the support layer is about 10 μm to 90 μm and preferably 20 μm to 50 μm.

### (Manufacturing Method)

The easy peel sealant film of the present embodiment can be manufactured by a blown film molding process. Specifically, the resin components of the low-density polyethylene, high-density polyethylene, propylene homopolymer, and linear low-density polyethylene, and additives as needed that are contained in the compositions of the peel layer and the support layer are mixed in advance or during film formation. Specific examples of the method of mixing during film formation include a method whereby the components mixed in a tumbler, a Henschel mixer or the like are fed into a film formation machine. Specific examples of the method of mixing in advance include a melt-mixing method using a single-shaft extruder, a dual-shaft extruder, a Banbury mixer, a kneader or the like.

Examples of the film manufacturing method include a cast process using a T-die as the film formation machine, and an blown film process using a ring die. Generally, a multilayer film such as the easy peel sealant film of the present embodiment is manufactured by coextrusion. However, compared with the blown film process, the cast process using a T-die leads to an increase in the size of the commercial production facility. As a result, large volumes of resin will be consumed for resin replacements during the manufacture of films having different resin compositions. In addition, the raw material resin tends to be subjected to thermal damage due to the high film formation temperature. Accordingly, for the easy peel sealant film of the present embodiment, preferably the coextrusion blown film process is adopted. The coextrusion blown film process includes water-cooled type and air-cooled type. According to the present embodiment, the coextrusion blown film process is preferably of the air-cooled type as it offers high film formation rate and enables wide film formation.

As described above, by setting the component contents of the compositions of the peel layer and the support layer of the present invention in specific ranges, stable film formation can be performed by the coextrusion blown film process.

It is believed that the coextrusion blown film process is suitable for the film formation according to the present embodiment for the following reasons.

The support layer and the peel layer of the easy peel sealant film of the present embodiment both have compositions that contain a polyethylene-based resin and a polypropylene-based resin. The melting point of the polyethylene-based resin is lower than the melting point of the polypropylene-based resin. Accordingly, during film formation, the polyethylene-based resin, which is relatively easy to melt, and the polypropylene-based resin, which is relatively hard to melt, coexist simultaneously in molten state.

During the film formation by the cast process using a T-die, in the molten polyethylene-based resin, the relatively hard-to-melt polypropylene-based resin is more strongly oriented in a direction of resin flow during film formation than in a direction perpendicular thereto. While the oriented polypropylene-based resin, being drawn into threads, is rapidly cooled by cooling rolls, a film is formed. It is believed that the polypropylene-based resin being drawn gives rise to stringing at the peel interface.

During film formation by the blown film process, in the molten polyethylene-based resin, the relatively hard-to-melt polypropylene-based resin is drawn in both the direction of resin flow during film formation and a direction perpendicular thereto, while being cooled gently by air. Accordingly, as opposed to the cast process, during film formation, the polypropylene-based resin is not subjected to rapid cooling while being drawn into threads. This is believed to suppress the development of stringing at the time of peeling. The blow-up ratio during film formation by the blown film process is preferably 2 to 3 from the viewpoint of reducing stringing.

### (Function/Effect of Easy Peel Sealant Film)

The cause of fluffing, the development of film residue, or knocking at the time of peeling the easy peel sealant film manufactured by molten film formation is not clear. However, if the viscosity ratio in the film of the main component of the same material as the adherend to the sub-component of a different material that inhibits adhesion with the adherend is improper, the sub-component tends to be oriented, during molten film formation, in a direction parallel with the film formation direction in fibrous form. It is believed that the orientation of the sub-component leads to the phenomenon of fluffing, film residue, or knocking at the time of peeling, and, depending on their degree, may even lower the product's value.

In the easy peel sealant film of the present embodiment, the content ratios of the respective resins contained in the compositions of the peel layer and the support layer are set within the respective specific ranges. Accordingly, the viscosity ratio is prevented from becoming improper even in the case of molten film formation. In this way, it is believed that the phenomenon that lowers the product's value at the time of peeling, such as fluffing, film residue, or knocking, can be avoided. In addition, in the case of the blown film process, the polymers contained in the compositions are harder to be oriented. Accordingly, fluffing and the like can be more effectively decreased.

### (Laminate)

The laminate of the present embodiment includes the easy peel sealant film of the present embodiment and the base material. The base material is affixed to and laminated on the support layer of the easy peel sealant film of the present embodiment.

Specific examples of the base material include uniaxial or biaxially oriented films of polyester, polyamide, polypropylene and the like: films obtained by vapor-depositing inorganic material, such as aluminum, silica, or alumina, on the uniaxial or biaxially oriented films; paper; and metal foils. One or more base materials may be laminated. The base materials may be subjected to a coloring, printing, or other process. Accordingly, a laminate which has excellent cosmetic appeal, gas barrier property, light shield property, pinhole resistance, and curl resistance, and which is easy to peel can be obtained.

Examples of the method for laminating the easy peel sealant film to the base material, and the method for laminating two or more base materials include a method of laminating by dry lamination process using an adhesive; a method of laminating by extrusion sandwich lamination process via polyethylene; and, in the case where another base material that is laminated adjacent to the support layer contains polyethylene, a thermal laminate process for thermal bonding using heating rolls. The laminating method, however, is not limited to the above examples.

The base material has a thickness of preferably 6 to 40 μm and more preferably 12 to 30 μm.

### (Uses of Laminate)

The laminate of the present embodiment may be formed into a bag for use as a packaging bag. The laminate of the present embodiment may also be used for an easy peel lid member of a cup or tray shaped container.

(Container with a Lid)

A container with a lid according to the present embodiment includes a lid member including the laminate of the present embodiment and a container.

The lid member including the laminate obtained by laminating the easy peel sealant film of the present embodiment may be affixed onto the container, which may be cup or tray shaped and have a polyethylene or polypropylene inner surface, by thermal adhesion. Specifically, after a liquid or solid content is filled or stored in the container, the lid member is placed on the container in such a way that the peel layer contacts an adhesive portion, such as on the flange portion of the container. Then, the lid member and the adhesive portion of the container are melted and sealed with a heating means, such as a heated plate or ultrasonic waves. In this way, an easy to open container with a lid according to the present embodiment with the contents enclosed therein is obtained.

On the peel surface on the adhesive portion of the container, after the lid member is peeled off, a portion corresponding to the peel layer of the easy peel sealant film remains. Accordingly, a peel trace is formed in the portion of the peel surface of the container and/or the lid member that has been sealed. The peel trace provides a proof that the container and the lid member had been reliably sealed before the lid member was peeled off. In this way, the seal state can be visually recognized from the peel trace, and, importantly, it can be proved that the product has never been opened after shipping.

### (Packaging Bag)

A packaging bag of the present embodiment includes the laminate of the present embodiment in a bag shape with the peel layer disposed on the inside. By sticking the faces of the peel layers of the laminate together, the packaging bag having a face-to-face heat seal portion can be obtained. Examples of the contents that are packaged include various food items such as processed meat, boiled beans, rice, and snacks.

In the container with a lid or the packaging bag including the laminate that includes the easy peel sealant film of the present embodiment, no cobweb-like fluffing is recognized on the peel surface of the container from which the lid member is peeled, or on the peel surface after peeling of the packaging bag. Also, no part of the laminate remains in the opening portion of the cup container as a filmy membrane. In addition, no knocking is caused at the time of peeling.

When the easy peel sealant film of the present embodiment is affixed to the adherend and then peeled off, the peel layer ruptures in the peel start portion at the start of peeling, and then the peeling proceeds between the peel layer and the support layer. Thus, the easy peel sealant film of the present embodiment is a sealant film of delamination type.

On the peel surface of the packaging bag according to the present embodiment, on the side of one peel layer, a part of the other peel layer remains attached after the opening. That is, a peel trace is formed on the side of one peel layer. The peel trace provides a proof that the packaging bag has been reliably sealed, as described above.

### (Peel Strength)

The peel strength of the lid member of the easy to open container with a lid according to the present embodiment may be measured by separating the lid member and container that are held in place at a tension rate of 300 mm/min in accordance with JIS K 7127. The peel strength is preferably 3N/15 mm in width to 16N/15 mm in width and more preferably 5N/15 mm in width to 13N/15 mm in width.

In the case of a packaging bag, a similar measurement process may be employed to measure the peel strength between the face-to-face heat seal portions of the peel layers adhered to each other on the inside of the bag. The peel strength is preferably 3N/15 mm in width to 19N/15 mm in width, and more preferably 7N/15 mm in width to 15N/15 mm in width.

In the laminate including the easy peel sealant film of the present embodiment, the peeling from the peel start portion to a peel end portion proceeds between the peel layer and the support layer. Accordingly, the peel strength refers to the interlayer strength between the peel layer and the support layer. Thus, a constant peel strength is exhibited regardless of the type of adherend and across a wide seal temperature band.

### EXAMPLES

In the following, the present embodiment will be described with reference to examples. The present embodiment, however, is not limited to the examples.

### <Resins Used>

LLDPE (linear low-density polyethylene): a metallocene-based polyethylene “Harmorex NF375B” manufactured by Japan Polyethylene Corporation, density=0.921 g/cm³, MFR=1.0 g/10 min

HDPE (high-density polyethylene): “Novatec HD HJ490N” manufactured by Japan Polyethylene Corporation, density=0.958 g/cm³, MFR=20.0 g/10 min

LDPE (low-density polyethylene): a high pressure low density polyethylene “Novatec LD LM360” manufactured by Japan Polyethylene Corporation, density=0.928 g/cm³, MFR=0.9 g/10 min

PP1 (propylene homopolymer): “PL600A” manufactured by SunAllomer Ltd., density=0.9 g/cm³, MFR=7.0 g/10 min

PP2 (propylene block copolymer): “PM671A” manufactured by SunAllomer Ltd., density=0.9 g/cm³, MFR=7 g/10 min

PP3 (propylene random copolymer): “WFX4” manufactured by Japan Polypropylene Corporation, density=0.9 g/cm³, MFR=7 g/10 min

PP4 (propylene homopolymer): “PM801A” manufactured by SunAllomer Ltd., density=0.9 g/cm³, MFR=13 g/10 min

PP5 (propylene homopolymer): “PL300A” manufactured by SunAllomer Ltd., density=0.9 g/cm³, MFR=1.2 g/10 min

PP6 (propylene homopolymer): “PM802A” manufactured by SunAllomer Ltd., density=0.9 g/cm³, MFR=20 g/10 min

### <Adherends Used>

Adherend 1: A commercially available round cup container made of polypropylene, with a flange portion having an outer diameter of 90 mm and an inner diameter of 76 mm

Adherend 2: A commercially available round cup container made of polyethylene, with a flange portion having an outer diameter of 90 mm and an inner diameter of 76 mm

### <Film Formation>

Using the raw materials shown in Tables 1 and 2, film formation was performed by means of the air-cooled three-layers blown film formation machines indicated below, under the conditions indicated below. Two-layers easy peel sealant films with a total thickness of 35 gun were obtained. In the easy peel sealant films obtained, the thickness of the peel layer was 5 μm, and the thickness of the support layer was 30 μm.

Peel layer extruder A: An extruder equipped with a screw with an outer diameter of 40 mm and a compression ratio of 3

### (Extrusion Temperature 230° C.)

Support layer extruder B: An extruder equipped with a screw with an outer diameter of 65 mm and a compression ratio of 2.5

### (Extrusion Temperature 230° C.)

Support layer extruder C: An extruder equipped with a screw with an outer diameter of 40 mm and a compression ratio of 3

### (Extrusion Temperature 190° C.)

Die: outer diameter 120 mm, lip gap 3.5 mm, temperature 230° C. Blow-up ratio: 2.3, film formation rate 22 m/min

### <Fabrication of Laminate>

The support layer of the obtained easy peel sealant film was subjected to a corona discharge process such that the surface wet tensile force became 42 mN/m.

The treated surface and a biaxially oriented polyethylene terephthalate film with a thickness of 12 μm were laminated one upon the other, using a two-part curing dry laminate adhesive, producing a laminate.

### Examples 1 to 5, Comparative Examples 1 to 3

<Fabrication of Container with Lid>

The obtained laminate, as the lid member, was placed on the container in such a way that the peel layer of the easy peel sealant film contacted the flange surface on the upper surface of the polypropylene or polyethylene round cup container. Using a ring-shaped heat seal device for top-surface, thermal adhesion was performed at the temperatures shown in Table 1, with a pressure of 0.2 MPa for a time of 1.0 second, whereby containers with a lid were fabricated.

### Examples 6 to 9

### <Fabrication of Packaging Bag>

The peel layer sides of the easy peel sealant film of the obtained laminate were superposed on one another, and thermal adhesion was performed at the temperatures shown in Table 2 with a pressure of 0.2 MPa for a time of 0.5 second, whereby packaging bags were fabricated.

### <Measurement of Peel Strength>

The fabricated containers with a lid and packaging bags were cut to obtain test pieces with a width of 15 mm. In accordance with JIS K 7127, the value obtained when pulled at a tension rate of 300 mm/min was measured as the peel strength.

### <Evaluation of Peel Appearance>

On the assumption that the fabricated containers with a lid and packaging bags would be peeled by the consumer holding them with fingers, a corresponding peeling operation was implemented. The appearance of the peel surface after peeling was evaluated by visual observation. Specifically, with respect to the containers with a lid, the presence or absence of fluffing on both sides of the peel surface, and the presence or absence of film residue were evaluated according to the following standards.

The presence or absence of fluffing on the peel surface of the packaging bags was evaluated.

Fluffing

Good: No fibrous resin observed (without fluffing).

Poor: Drawn fibrous resin attached to both peel surfaces (with fluffing).

Film Residue

Good: No remaining film extending into the container observed (without film residue).

Poor: Transparent and thin piece of film observed on the inside of adherend (with film residue).

The evaluation results are shown in Tables 1 and 2.

### <Blown Film Formation Stability>

During film formation, a tubular film vertically rising out of the die becomes expanded, forming a hollow tubular film (which may be hereafter referred to as “bubble”). The bubble was visually observed to evaluate the blown film formation characteristics according to the following standards.

Good: Bubble so stable as to appear stationary.

Poor: Bubble diameter changing. Or bubble moves right and left, for example, and therefore unstable.

The evaluation results are shown in Tables 1 and 2.

### <Evaluation of Knocking>

On the assumption that the fabricated containers with a lid would be peeled by the consumer holding them with fingers, a corresponding peeling operation was implemented. The presence or absence of knocking was evaluated according to the following standards.

Good: Smoothly peeled off (without knocking).

Poor: Sense of being caught felt during peeling off (with knocking).

The evaluation results are shown in Tables 1 and 2.

TABLE 1

| | | | Lid member heat seal (adherend 1) | | | Lid member heat seal (adherend 2) | | | | |
|---|---|---|---|---|---|---|---|---|---|---|
| | Support layer | Peel layer | Top: Peel strength (N/15 mm) | | | Top: Peel strength (N/15 mm) | | | | |
| | Raw | Raw | Middle: Peel portion fluffing | | | Middle: Peel portion fluffing | | | Blown film | |
| | material | material | Bottom: Peel portion film residue | | | Bottom: Peel portion film residue | | | formation | |
| | (%) | (%) | 170° C. | 190° C. | 210° C. | 170° C. | 190° C. | 210° C. | stability | Knocking |
| Example 1 | LLDPE | LDPE | 8.2 | 8.1 | 8.3 | 10.2 | 9.5 | 9.2 | Good | Good |
| | (100) | (60) | Good | Good | Good | Good | Good | Good | | |
| | | HDPE | Good | Good | Good | Good | Good | Good | | |
| | | (10) | | | | | | | | |
| | | PP1 | | | | | | | | |
| | | (30) | | | | | | | | |
| Example 2 | LLDPE | LDPE | 9.9 | 10.1 | 11.7 | 10.5 | 10.8 | 11.4 | Good | Good |
| | (80) | (60) | Good | Good | Good | Good | Good | Good | | |
| | PP1 | HDPE | Good | Good | Good | Good | Good | Good | | |
| | (20) | (10) | | | | | | | | |
| | | PP1 | | | | | | | | |
| | | (30) | | | | | | | | |
| Example 3 | LLDPE | LDPE | 11.4 | 11.8 | 12.6 | 12.5 | 13.1 | 12.8 | Good | Good |
| | (70) | (60) | Good | Good | Good | Good | Good | Good | | |
| | PP1 | HDPE | Good | Good | Good | Good | Good | Good | | |
| | (30) | (10) | | | | | | | | |
| | | PP1 | | | | | | | | |
| | | (30) | | | | | | | | |
| Example 4 | LLDPE | LDPE | 14.7 | 15.2 | 15.5 | 10.8 | 11.4 | 11.3 | Good | Good |
| | (100) | (40) | Good | Good | Good | Good | Good | Good | | |
| | | HDPE | Good | Good | Good | Good | Good | Good | | |
| | | (20) | | | | | | | | |
| | | PP1 | | | | | | | | |
| | | (40) | | | | | | | | |
| Example 5 | LLDPE | LDPE | 4.5 | 4.8 | 5.2 | 6.5 | 7 | 7.2 | Good | Good |
| | (100) | (60) | Good | Good | Good | Good | Good | Good | | |
| | | HDPE | Good | Good | Good | Good | Good | Good | | |
| | | (10) | | | | | | | | |
| | | PP5 | | | | | | | | |
| | | (30) | | | | | | | | |
| Comparative | LLDPE | LDPE | 7.5 | 8.3 | 7.6 | 8.2 | 7.8 | 8.5 | Good | Poor |
| Example 1 | (100) | (60) | Poor | Poor | Poor | Poor | Poor | Poor | | |
| | | HDPE | Poor | Poor | Poor | Poor | Poor | Poor | | |
| | | (10) | | | | | | | | |
| | | PP2 | | | | | | | | |
| | | (30) | | | | | | | | |
| Comparative | LLDPE | LDPE | 8 | 8.2 | 8.5 | 8.1 | 8.5 | 8.8 | Good | Poor |
| Example 2 | (100) | (60) | Poor | Poor | Poor | Poor | Poor | Poor | | |
| | | HDPE | Poor | Poor | Poor | Poor | Poor | Poor | | |
| | | (10) | | | | | | | | |
| | | PP3 | | | | | | | | |
| | | (30) | | | | | | | | |
| Comparative | LLDPE | LDPE | 7.7 | 7.8 | 10.5 | 8.5 | 8.8 | 9.7 | Good | Good |
| Example 3 | (100) | (60) | Poor | Poor | Poor | Poor | Poor | Poor | | |
| | | HDPE | Good | Good | Good | Good | Good | Good | | |
| | | (10) | | | | | | | | |
| | | PP4 | | | | | | | | |
| | | (30) | | | | | | | | |

| | | | | | |
|---|---|---|---|---|---|
| Comparative | LLDPE | LDPE | Un-measurable due to film formation incapability | Poor | — |
| Example 4 | (70) | (60) | | | |
| | PP1 | HDPE | | | |
| | (30) | (10) | | | |
| | | PP6 | | | |
| | | (30) | | | |

TABLE 2

| | | | Face-to-face heat seal | | | |
|---|---|---|---|---|---|---|
| | | | (packaging bag) | | | |
| | Support layer | Peel layer | Top: Peel strength (N/15 mm) | | | Blown film |
| | Raw material | Raw material | Bottom: Peel portion fluffing | | | formation |
| | (%) | (%) | 170° C. | 190° C. | 210° C. | stability |
| Example 6 | LLDPE1 (100) | LDPE (60) | 18.7 | 17.2 | 18.5 | Good |
| | | HDPE1 (10) | None | None | None | |
| | | PP1 (30) | | | | |
| Example 7 | LLDPE 1(80) | LDPE (60) | 15.3 | 15.4 | 15.6 | Good |
| | PP1 (20) | HDPE1 (10) | None | None | None | |
| | | PP1 (30) | | | | |
| Example 8 | LLDPE1 (70) | LDPE (60) | 15.1 | 15.2 | 15.7 | Good |
| | PP1 (30) | HDPE1 (10) | None | None | None | |
| | | PP1 (30) | | | | |
| Example 9 | LLDPE1 (100) | LDPE (40) | 15.9 | 16.3 | 16.1 | Good |
| | | HDPE1 (20) | None | None | None | |
| | | PP1 (40) | | | | |

In Example 1 to Example 5, in a wide temperature range of 170° C. to 210° C., delamination peel strengths in a certain range were stably exhibited. The sealable temperature range, indicating stable peel strengths, was wide.

In Examples 2 and 3, propylene homopolymer was contained in the support layer. Accordingly, easy peel property at higher peel strengths than in Example 1 was exhibited.

In Example 4, compared with Example 1, the ratio of propylene homopolymer and high-density polyethylene in the peel layer was increased. Accordingly, higher peel strengths than the peel strengths of Example 1 were exhibited. No film residue was observed.

In Example 5, in which a propylene homopolymer with a MFR of 1.2 g/10 min was used, lower peel strengths than in Example 1 were exhibited. However, peel appearance was good.

In Comparative Example 1, as opposed to Example 1, propylene block copolymer was used in the peel layer. As a result, film residue and fluffing resulted.

In Comparative Example 2, as opposed to Example 1, propylene random copolymer was used in the peel layer. As a result, film residue and fluffing resulted.

In Comparative Example 3, as opposed to Example 1, a propylene homopolymer having a MFR in excess of 9 g/10 min (13 g/10 min) was used in the peel layer. As a result, while no film residue was produced, fluffing resulted.

In Comparative Example 4, a propylene homopolymer having a MFR of 20 g/10 min was used. As a result, the bubble became unstable during film formation, so that blown film moldability was not proper.

In Example 6 to Example 9, in a wide temperature range of 170° C. to 210° C., peel strengths in a certain range were stably exhibited. The sealable temperature range, indicating stable peel strengths, was wide.

In Examples 6 to 9, easy peel property at high peel strengths were exhibited.

An easy peel sealant film according to an embodiment of the present disclosure may be an easy peel sealant film including at least two layers including a support layer and a peel layer. The support layer may have a composition of 100 to 70 mass % of linear low-density polyethylene and 0 to 30 mass % of propylene homopolymer. The peel layer may have a composition of 40 to 60 mass % of low-density polyethylene, 10 to 20 mass % of high-density polyethylene, and 20 to 50 mass % of propylene homopolymer. The propylene homopolymer in the support layer may have a melt flow rate of 1 g/10 min to 9 g/10 min. The propylene homopolymer in the peel layer may have a melt flow rate of 1 g/10 min to 9 g/10 min.

A laminate according to an embodiment of the present disclosure may include the easy peel sealant film and a base material.

A container with a lid according to an embodiment of the present disclosure may include a lid member having the laminate and a container.

A packaging bag according to an embodiment of the present disclosure may include the laminate in a bag shape with the peel layer side located on the inside.

An easy peel sealant film manufacturing method according to an embodiment of the present disclosure may include an blown film molding process for manufacturing.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An easy peel sealant film comprising at least a support layer and a peel layer, wherein
the support layer has a composition which contains 100 to 70 mass % of a linear low-density polyethylene, and 0 to 30 mass % of a propylene homopolymer,
the peel layer has a composition which contains 40 to 60 mass % of a low-density polyethylene, 10 to 20 mass % of a high-density polyethylene, and 20 to 50 mass % of a propylene homopolymer, and
the propylene homopolymer in the support layer and the propylene homopolymer in the peel layer have a melt flow rate of 1 g/10 min to 9 g/10 min.

2. A laminate comprising:
the easy peel sealant film according to claim 1; and
a base material.

3. A container with a lid, comprising:
a lid member including the laminate according to claim 2; and
a container.

4. A packaging bag comprising the laminate according to claim 2 in a bag shape with the peel layer disposed on an inner side.

5. A method for manufacturing the easy peel sealant film of claim 1, the method comprising forming a film using an blown film molding process.
